(19) United States
(12) Patent Application Publication
(10) Pub. No.: US 2019/0252831 A1
(43) Pub. Date: Aug. 15, 2019

(54) CONNECTOR ASSEMBLY WITH GROUNGING CLAMP SYSTEM

(71) Applicant: COMMSCOPE TECHNOLOGIES LLC, Hickory, NE (US)

(72) Inventor: Gordon John WHITE, Gloucester, Gloucestershire (GB)

(73) Assignee: COMMSCOPE TECHNOLOGIES LLC, Hickory, NC (US)

(21) Appl. No.: 16/316,262

(22) PCT Filed: Jul. 6, 2017
(86) PCT No.: PCT/US2017/040947

§ 371 Date: Jan. 8, 2019

Related U.S. Application Data
(60) Provisional application No. 62/359,884, filed on Jul. 8, 2016.

(51) Int. Cl. H01R 13/6592; H01R 13/58

(52) U.S. Cl. CPC H01R 13/6592; H01R 24/64; H01R 13/5837

(57) ABSTRACT

A connector assembly (10) is disclosed in which a connector part (12) and a cable manager part (20) are provided. The cable manager part (20) can be provided with a housing assembly (70, 170, 270, 370) that contains a pair of clamp members (74, 174, 274, 374) that function together to ensure a grounded connection between the connector assembly (10) and a conductive element (5) of a cable (4).

### CROSS-REFERENCE TO RELATED APPLICATION

This application is being filed on Jul. 6, 2017 as a PCT International Patent Application and claims the benefit of U.S. Patent Application Ser. No. 62/359,884, filed on Jul. 8, 2016, the disclosure of which is incorporated herein by reference in its entirety.

### BACKGROUND

Electrical connectors are useful for providing a connection point for telecommunications systems. For example, RJ-type connectors can be provided as wall sockets wherein electronic data cables are terminated and mating electrical plugs can be inserted into the sockets. Frequently, this termination process occurs in the field and at the actual location where the cables to be attached to the connectors are being installed. In such instances, it is often necessary to provide a grounding connection between the cable and its attached connector.

### SUMMARY

A connector assembly is disclosed. Connector assemblies including grounding clamps are disclosed. The disclosed connector assemblies provide for a compact cable clamp/shield connection method that can accommodate a large range of cable sizes. For example, the disclosed clamp can accommodate cables ranging from 4.6 to 9.0 mm. Another feature of the disclosed clamps is that all parts of the clamping features are inboard of the sides of the connector assembly or jack such that no protrusions exist. As the connector assemblies or jacks are to be used in high density applications, where in some cases they are mounted side by side and or back to back, any protrusions from a clamp outside the connector assembly bodies would prevent this configuration.

In one aspect, the connector assembly includes a connector part having a jack cavity and a cable manager part. The cable manager part can be configured to be installed within the connector part to form the connector assembly. The cable manager part may include a housing assembly having a central aperture through which a cable having an exposed conductive element, such as a metal shield or sheath, can extend. The connector assembly may also include a grounding clamp assembly held within the housing assembly.

In one embodiment, the connector assembly can include a connector part having a jack cavity and a cable manager part. The cable manager part is conductively attached to the connector part. The cable manager part includes a housing assembly having a housing part defining a central aperture through which a cable having an exposed conductive element can extend. A grounding clamp assembly is held within the housing part, the grounding clamp assembly including a first clamp member and an oppositely arranged second clamp member, the first and second clamp members being movable between an open position and a clamped position. In the open position, the clamp members are disposed away from the central aperture and are in a relaxed, non-deflected state. In the clamped position, the clamp members extend across the central aperture and contact the conductive element of an inserted cable by one or both of bending around the conductive element in a deflected state and rotating against the conductive element.

### BRIEF DESCRIPTION OF THE DRAWINGS

Non-limiting and non-exhaustive embodiments are described with reference to the following figures, which are not necessarily drawn to scale, wherein like reference numerals refer to like parts throughout the various views unless otherwise specified.

FIG. 1 is a perspective view of a main body of a telecommunications connector cable manager part having features that are examples of aspects in accordance with the principles of the present disclosure, wherein a cable is received within the main body.

FIG. 2 is a top view of the cable manager part main body shown in FIG. 1.

FIG. 3 is a perspective view of a cable connected to a telecommunications connector having the connector part and a cable manager part having features that are examples of aspects in accordance with the principles of the present disclosure.

FIG. 4 is a perspective view of the cable shown in FIGS. 1 and 3, removed from the telecommunications connector.

FIG. 5 is a perspective view of a connector part usable with the cable manager part and cable shown in FIG. 1.

FIG. 6 is a perspective view of the cable manager part shown in FIG. 1, with a lacing fixture shown as being attached to a housing assembly.

FIG. 7 is a front view of the cable manager part shown in FIG. 6.

FIG. 8 is a front view of the housing assembly shown in FIG. 6.

FIG. 9 is an exploded perspective view of the cable manager part shown in FIG. 9.

FIG. 10 is a perspective view of a main body of the housing assembly shown in FIG. 6.

FIG. 11 is a front view of the main body shown in FIG. 10.

FIG. 12 is a first side view of the main body shown in FIG. 10.

FIG. 13 is a second side view of the main body shown in FIG. 10.

FIG. 14 is a front perspective view of a clamp member of the housing assembly shown in FIG. 6.

FIG. 15 is a rear perspective view of the clamp member shown in FIG. 14.

FIG. 16 is a side view of the clamp member shown in FIG. 14.

FIG. 17 is a front view of the clamp member shown in FIG. 14.

FIG. 18 is a top view of the clamp member shown in FIG. 14.

FIG. 19 is a perspective view of a second embodiment of a cable manager part for use with the connector part of FIG. 4 having features that are examples of aspects in accordance with the principles of the present disclosure.

FIG. 20 is a top view of the connector part shown in FIG. 19, with a cable 6 inserted, wherein the connector part is in an unclamped state.

FIG. 21 is a top view of the connector part shown in FIG. 19, with a cable 6 inserted, wherein the connector part is in a clamped state.

FIG. 22 is a top perspective view of a main body of the connector part shown in FIG. 19.

FIG. 23 is a bottom perspective view of the main body shown in FIG. 22.

FIG. 24 is a top perspective view of a rotational clamp member of the connector part shown in FIG. 19.

FIG. 25 is a bottom perspective view of the rotational clamp member shown in FIG. 24.

FIG. 26 is a top perspective view of a third embodiment of a cable manager part for use with the connector part of FIG. 5 having features that are examples of aspects in accordance with the principles of the present disclosure.

FIG. 27 is a top view of the cable manager part shown in FIG. 26.

FIG. 28 is a top view of the cable manager part shown in FIG. 26 with the cable manager part in an unclamped position.

FIG. 29 is a top view of the cable manager part shown in FIG. 26 with the cable manager part in a clamped position.

FIG. 30 is a top perspective view of a main body of the cable manager part shown in FIG. 26.

FIG. 31 is a bottom perspective view of the main body shown in FIG. 30.

FIG. 32 is a top perspective view of a rotational clamp member of the cable manager part shown in FIG. 26.

FIG. 33 is a bottom perspective view of the main body shown in FIG. 32.

FIG. 34 is a top perspective view of a clamp member of the cable manager part shown in FIG. 26.

FIG. 35 is a partial top perspective view of a fourth embodiment of a cable manager part for use with the connector part of FIG. 5 having features that are examples of aspects in accordance with the principles of the present disclosure.

FIG. 36 is a top view of the cable manager part shown in FIG. 35 in an unclamped position.

FIG. 37 is a top view of the cable manager part shown in FIG. 35 in a partially clamped position.

FIG. 38 is a top view of the cable manager part shown in FIG. 35 in a clamped position.

FIG. 39 is a top perspective view of a main body of the cable manager part shown in FIG. 35.

FIG. 40 is a bottom perspective view of a main body of the cable manager part shown in FIG. 35.

FIG. 41 is a top perspective view of a clamp member of the cable manager part shown in FIG. 35.

FIG. 42 is a top perspective view of a clamp arm of the cable manager part shown in FIG. 35.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

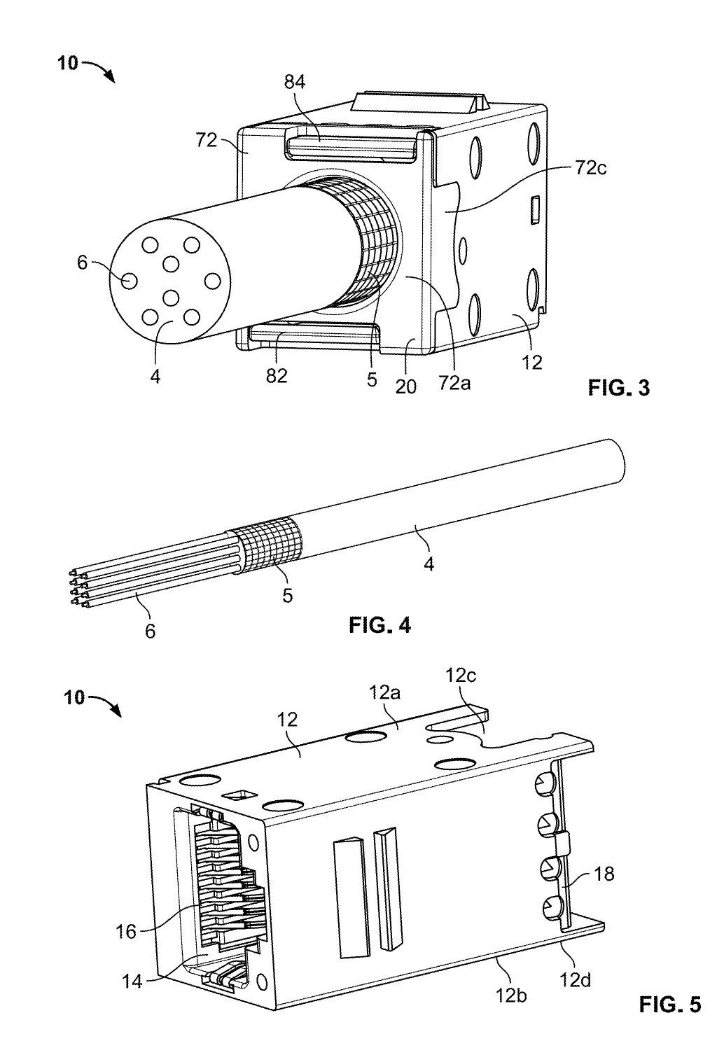

A telecommunications connector 10 for grounded connection with a cable 4 having a conductive element 5 and a plurality of wires 6 is shown. One example of a suitable cable 4 is shown at FIG. 3. As used herein, term “conductive element” is defined as including any type of conductive element, shield, or sheath disposed over the cable jacket, including metal braids, meshes, foils, drain wires, and combinations thereof. In one example, the cable 4 includes a plurality of insulated copper wires 6, for example, four sets of twisted wire pairs, while the connectors 10 are modular or RJ-type connectors. As shown, the telecommunications connector 10 has a connector part 12 which includes a jack cavity 14 for receiving a corresponding plug (not shown). As most easily seen at FIG. 4, the connector part 12 can include a plurality of electrical contact members 16 for which electrical connection to the wires 6 will be made through a termination and connection process. The connector part 12 is further provided with a pair of cutting edges 18 which are designed to cut the wires 6 of the cable 4 during the termination process. As shown, the connector part 12 has conductive sidewalls 12a, 12b which are formed from a conductive material, such as a metal material. In one aspect, the sidewalls 12a, 12b each define a respective recess portion 12c, 12d. The recess portions 12c, 12d receive and connect to the housing assembly 70 first and second sides (e.g. 72b, 72c) respectively, such that conductive contact is established between the housing assembly 70 and the sidewalls 12a, 12b of the connector 10. Accordingly, the connector 10 is grounded to the cable conductive element 5 via the housing assembly 70 and the sidewalls 12a, 12b. One example of a suitable termination process and connector part is shown and described in Spain patent application P201530417, entitled Connector Assembly with Grounding Spring and filed on 27 Mar. 2015, the entirety of which is incorporated by reference herein. Another example of a suitable termination process and connector part is shown and described in Spain patent application P201531199, entitled Connector Assembly with Grounding Spring Clamp and filed on 13 Aug. 2015, the entirety of which is incorporated by reference herein.

The connector part 12 and the cable manager part 20 used in the various embodiments may be configured in a complementary manner, so that the connector part 12 is able to engage with the cable manager part 20 only in one orientation. The cable manager part 20 can be further provided with a main body for facilitating connection between the conductors in the wires 6 and the contact members 16. The cable manager part 20 can also include a lacing structure 30 to place the wires 6 in the appropriate orientation for termination. An example lacing structure 30 suitable for use with the cable manager part 20 disclosed herein can be found in Spain patent application P201530372 entitled Connector with Separable Lacing Fixture and filed on 20 Mar. 2015, the entirety of which is incorporated by reference herein.

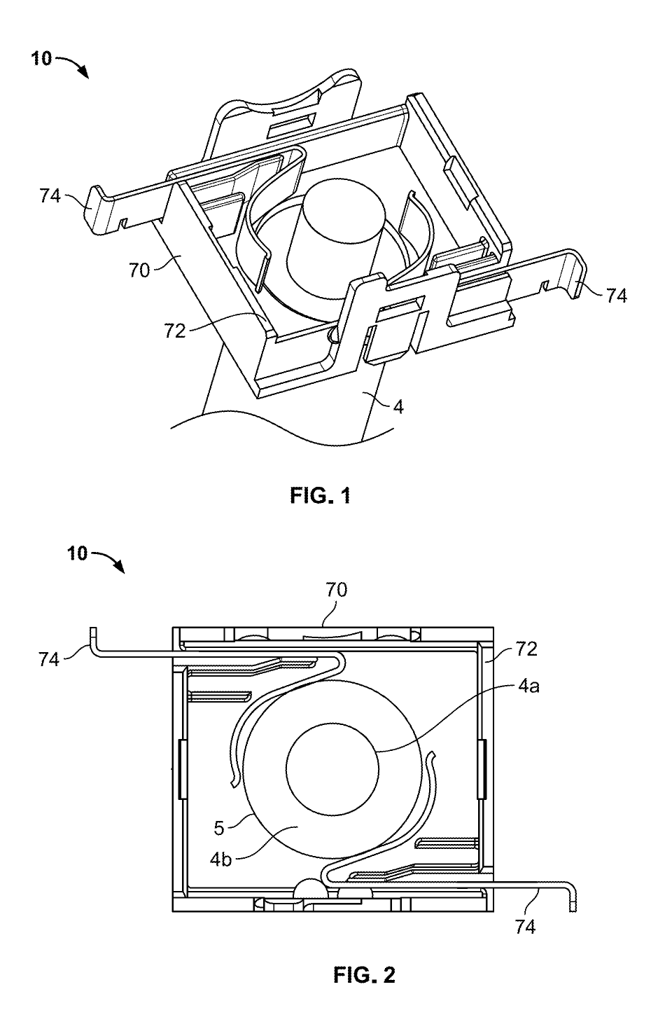

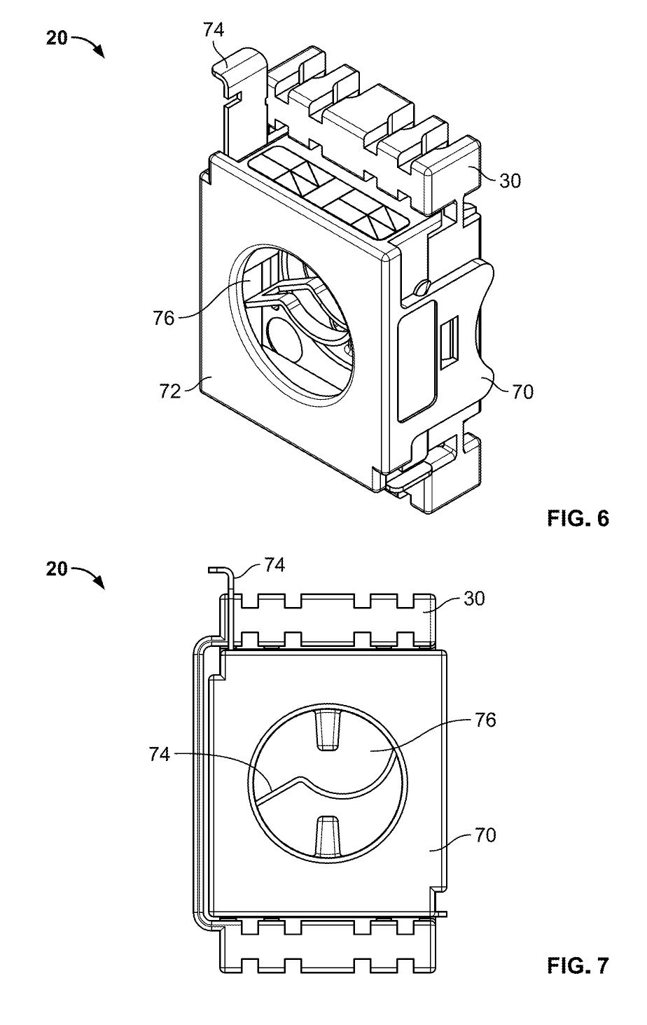

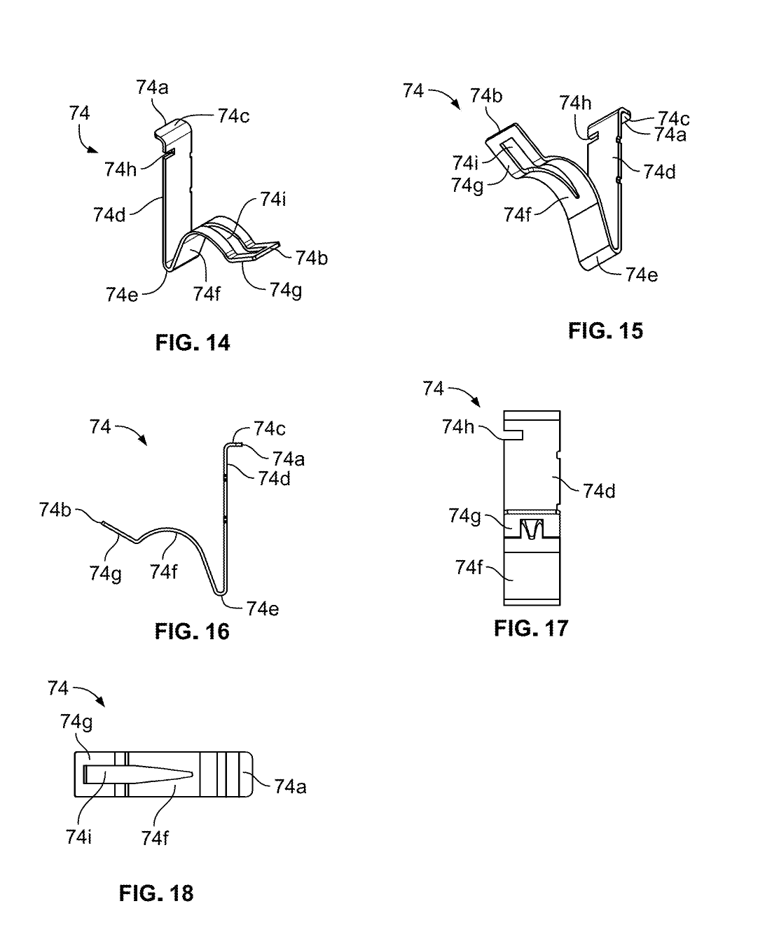

Referring to FIGS. 1-2 and 6-18 a first embodiment of a connector assembly 10 having a cable manager part 20 with a housing assembly 70 and lacing fixture 30 is illustrated. The housing assembly 70 is shown in isolation from the remainder of the connector assembly 10 at FIGS. 1-2 and 8. In one aspect, the housing assembly 70 includes a main body 72 that receives a pair of clamp members 74. Taken together, the clamp members 74 form a grounding clamp assembly that enable grounding contact with the cable sheath 5. Of note, FIGS. 2, 20, 21, 27 and 36 shows two differently sized cables 4a, 4b that can be accommodated by the grounding clamp assembly, wherein the cable 4a has a diameter of about 4.6 millimeters and the cable 4b has a diameter of about 9.0 millimeters. This range in cable sizes that can be accommodated is due to the elastic nature and/or the rotatable movement of the clamp members. The grounding clamp assembly can be configured to accommodate other ranges of cable sizes without departing from the concepts presented herein.

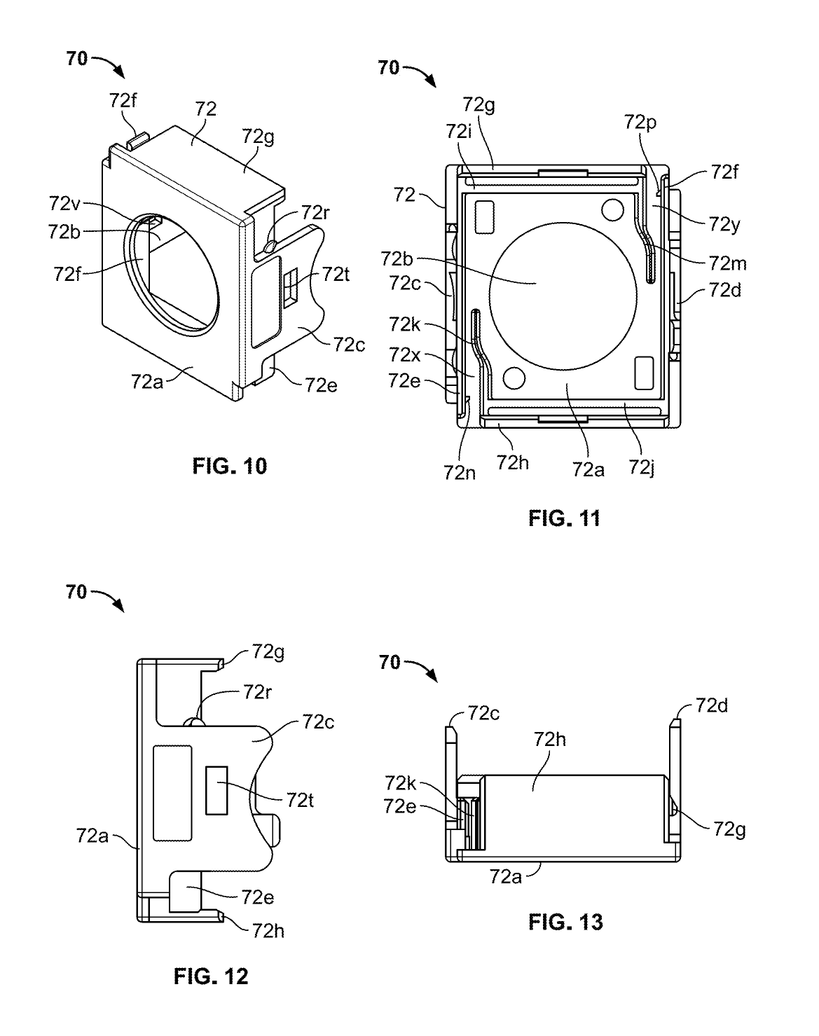

The housing assembly 70 is shown as having a main body 72 with an end wall 72a within which a central aperture 72b is defined. In one aspect, a plurality of sidewalls are provided that extend from the end wall 72a. For example, and as most easily seen at FIGS. 10-13, sidewalls 72c to 72m can be provided. Sidewalls 72e, 72f, 72g, and 72h generally form an outer perimeter sidewall structure while sidewalls 72c, 72d are configured to be received within correspondingly shaped recesses of the connector 12. Interior sidewalls 72m, 72k are configured to provide a support structure for the lacing fixture 30. Interior sidewalls 72k, 72m are provided in an offset relationship with sidewalls 72e, 72f to form a channel 72x, 72y within which the clamp members 74 can be received and guided.

The main body 72 also includes a latch members 72n, 72p respectively protruding from end walls 72e, 72f. The latch members 72n, 72b are each for engaging a clamp member 74 which is received into a channel 72x, 72y respectively defined between sidewalls 72e/72k and 72f/72m. This engagement ensures that the clamp members 74 are held securely in the clamped position such that full engagement between the clamp members 74 and the sheath 5 is attained at all times. The main body 72 additionally includes protrusions 72r, 72s and apertures 72t, 72v for enabling a snap-fit type engagement between the housing part main body 72 and the connector 12.

The clamp member 74 is shown in isolation from the remainder of the housing assembly 10 at FIGS. 12-16. The housing assembly 10 includes two clamp members 74 that cooperate with each other to provide a clamping function against the cable sheath 5 once a cable is inserted into the aperture 72b of the housing part main body 72. As shown, the clamp member 74 extends continuously between a first end 74a and a second end 74b and can be defined as having a handle portion 74c, a slide portion 74d, bend portion 74e, a clamping portion 74f, and an end portion 74g. A notch 74h is provided in the slide portion 74d which engages with the latch portions 74f/74n to hold the clamp member in a clamped position once the clamp member slide portion 74d has been fully inserted into the channel 74x/74y. The handle portion 74c acts as a stop member against the end of the sidewall 74e/74f once full insertion has been achieved and also acts as a grasping element for an operator for pulling the clamp member away from the housing part main body 72. The clamp member 74 is also provided with an aperture 74i which extends through the clamp portion 74f and the end portion 74g. The aperture 74i enhances the flexibility of the clamp portion 74f of the clamp member 74 such that the clamp portion 74f can more easily conform around variously sized cables 6.

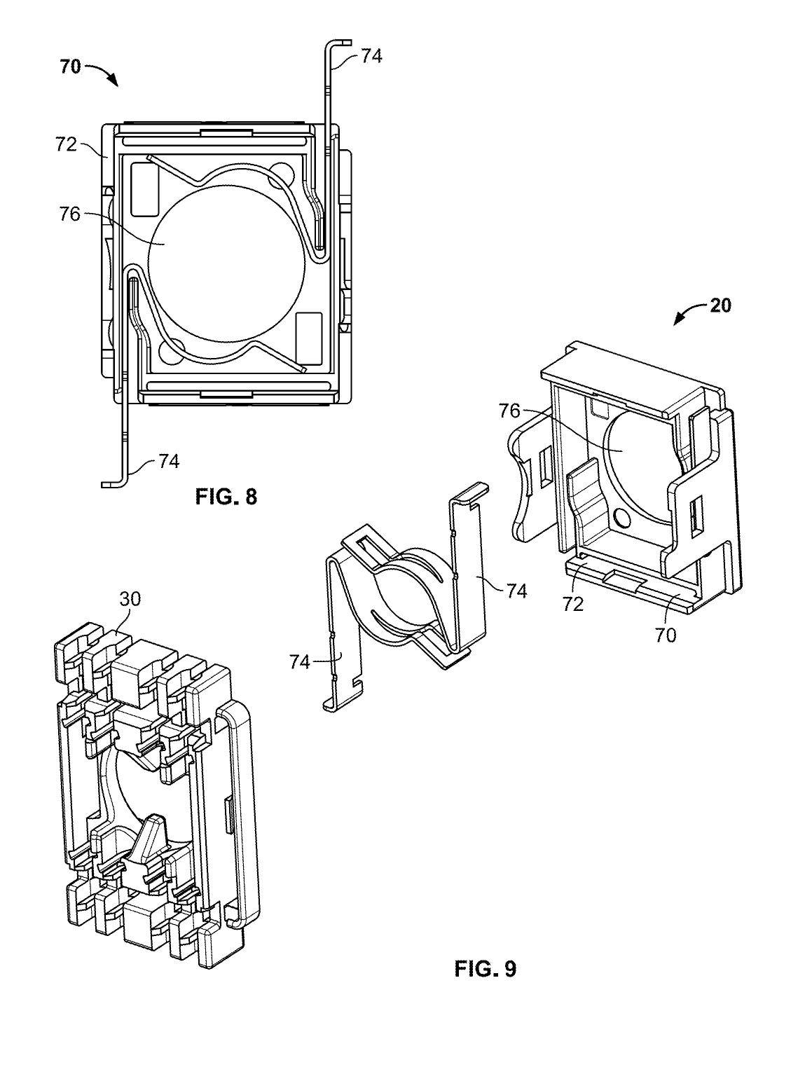

In operation, the clamp members 74 are slidably engaged within the main body 72 and can slide between a clamped position and an open position along axes that are parallel with the slide portions 74d. In the clamped position, the clamp members handle portions 74c are pressed towards the main body 72 such that the clamping portions 72f extend into the central aperture area 72b and engage against the cable sheath 5 of the cable 4. As mentioned above, in the fully clamped position, the notches 74h of the clamp members are engaged with the latches 72n, 72p such that the clamp members 74 remain in the clamped position until released by an operator. To move the clamp members 74 into the open position, the clamp member handle portions 74c are first deflected towards each other (i.e. towards aperture 72b) to disengage the slid portion notches 74h from the latches 72n, 72p and are then pulled away from the main body 72 in a direction parallel to the slide portion 74d, such that the clamping portions 72f are outside of the central aperture area 72b. The open position can be viewed at FIGS. 1 and 8.

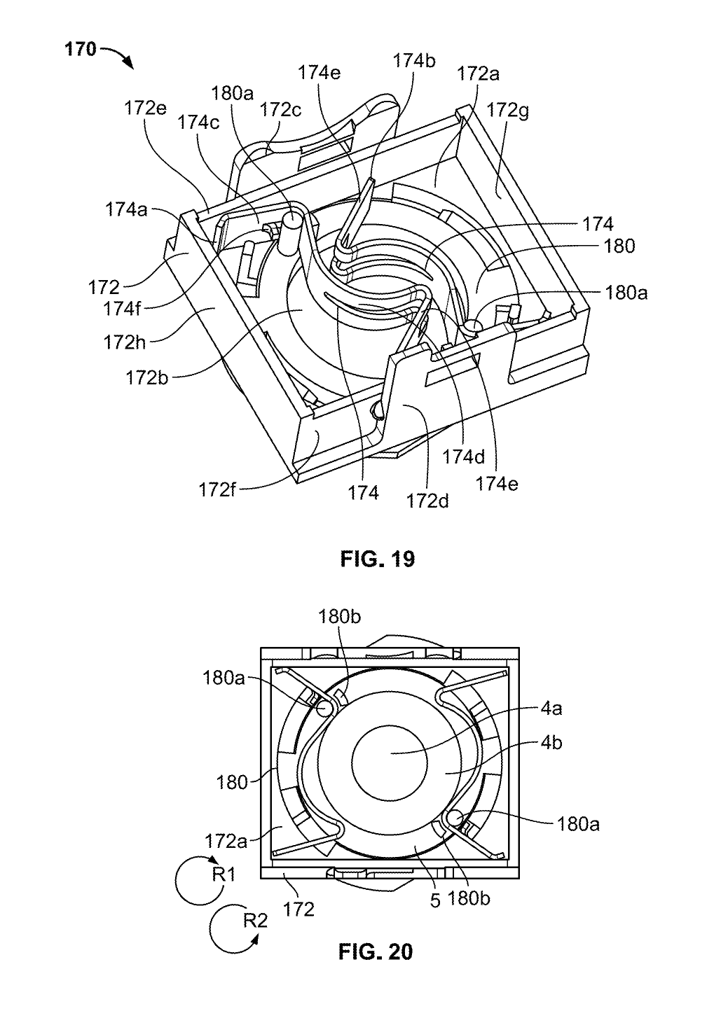

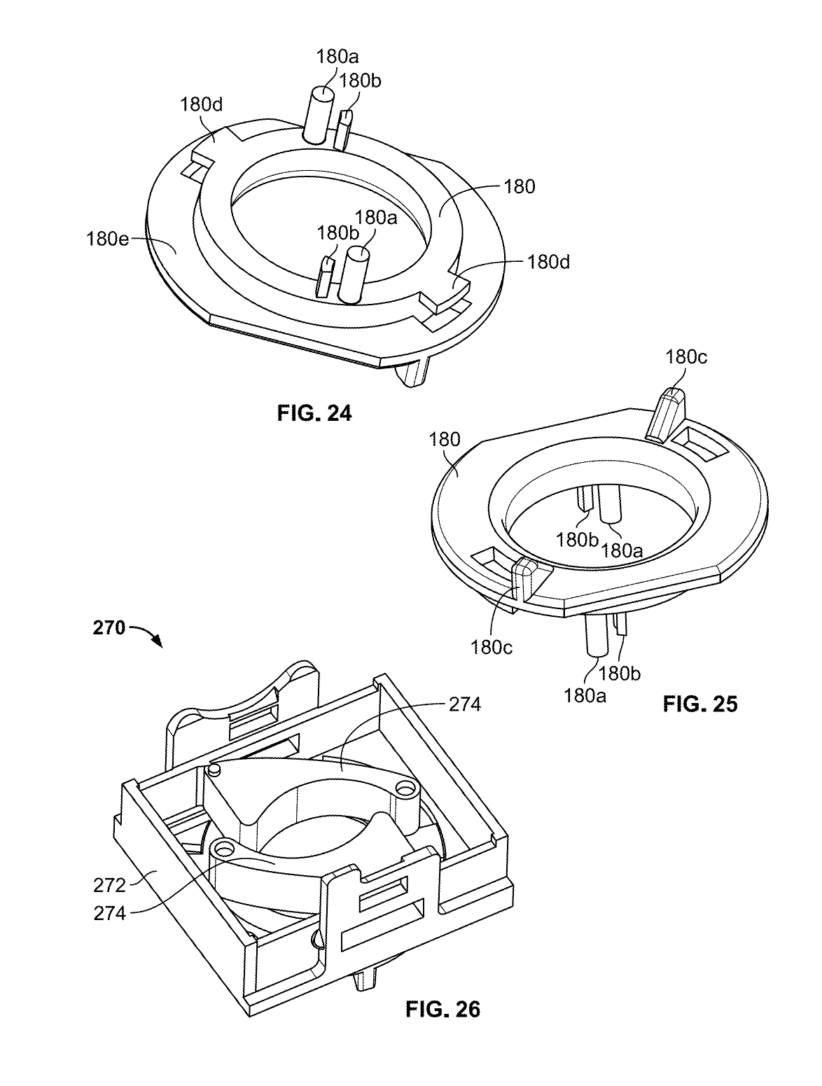

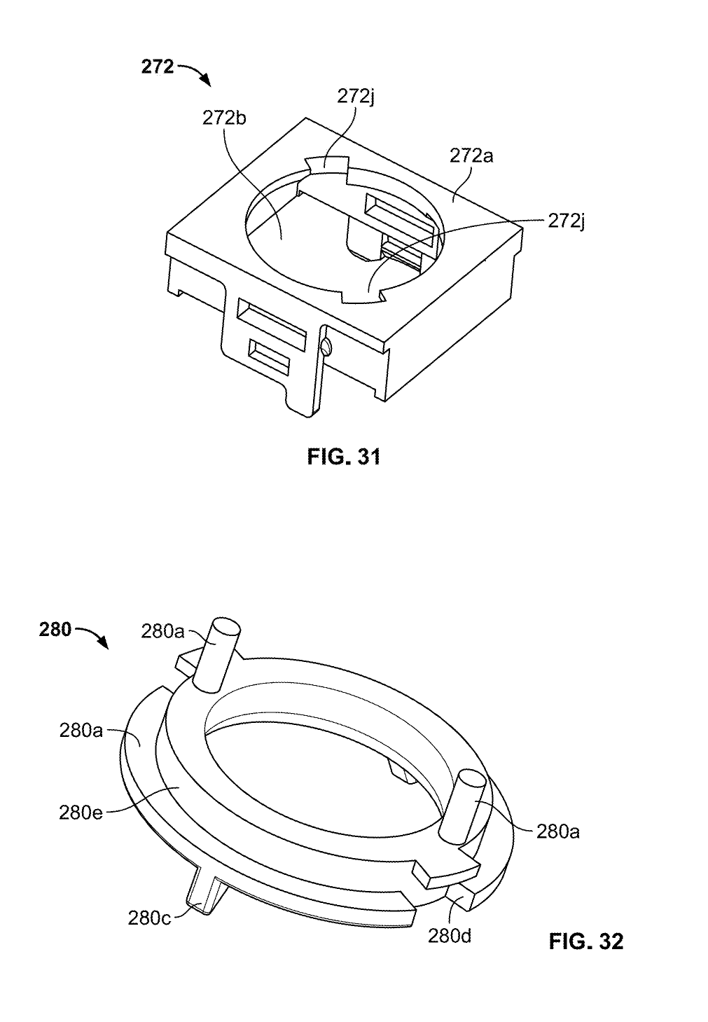

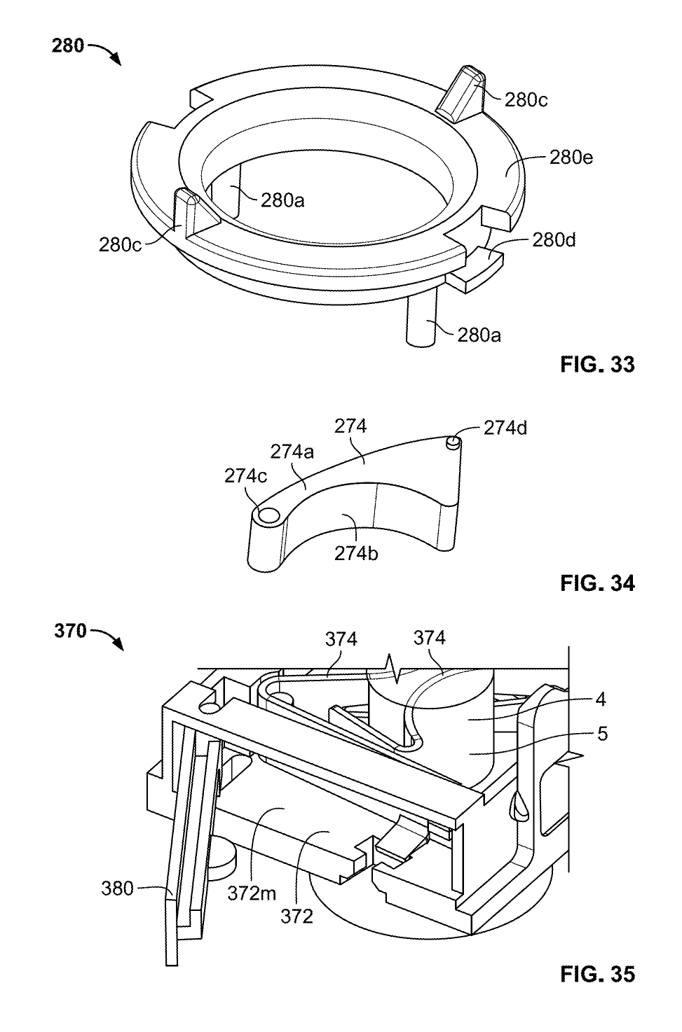

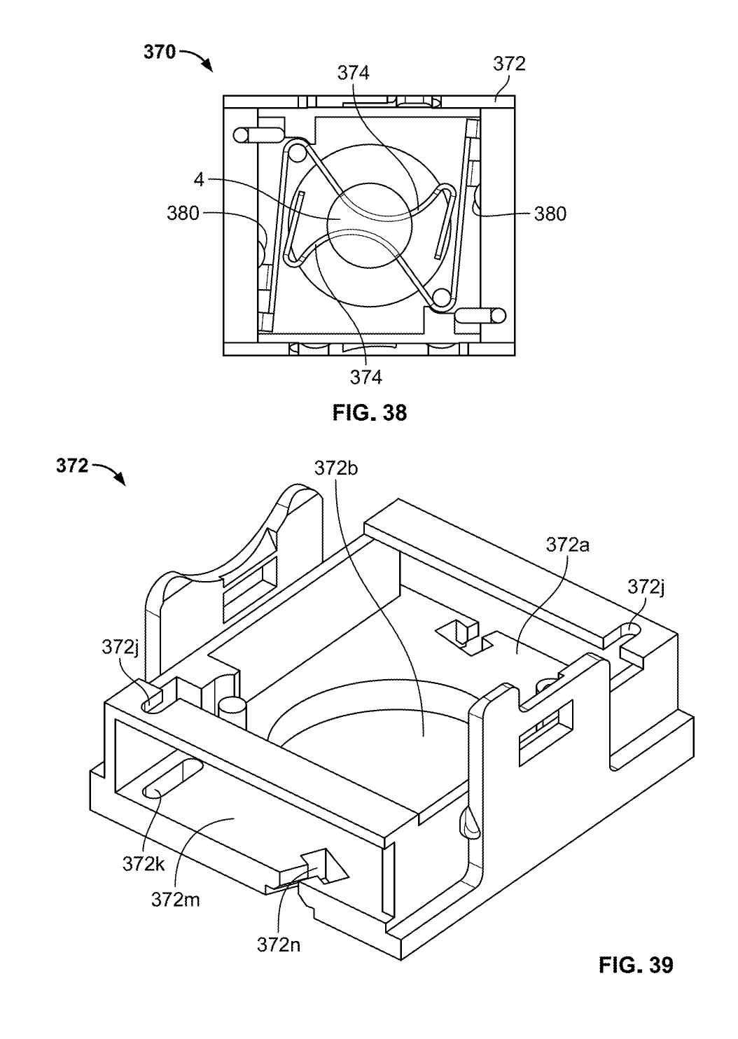

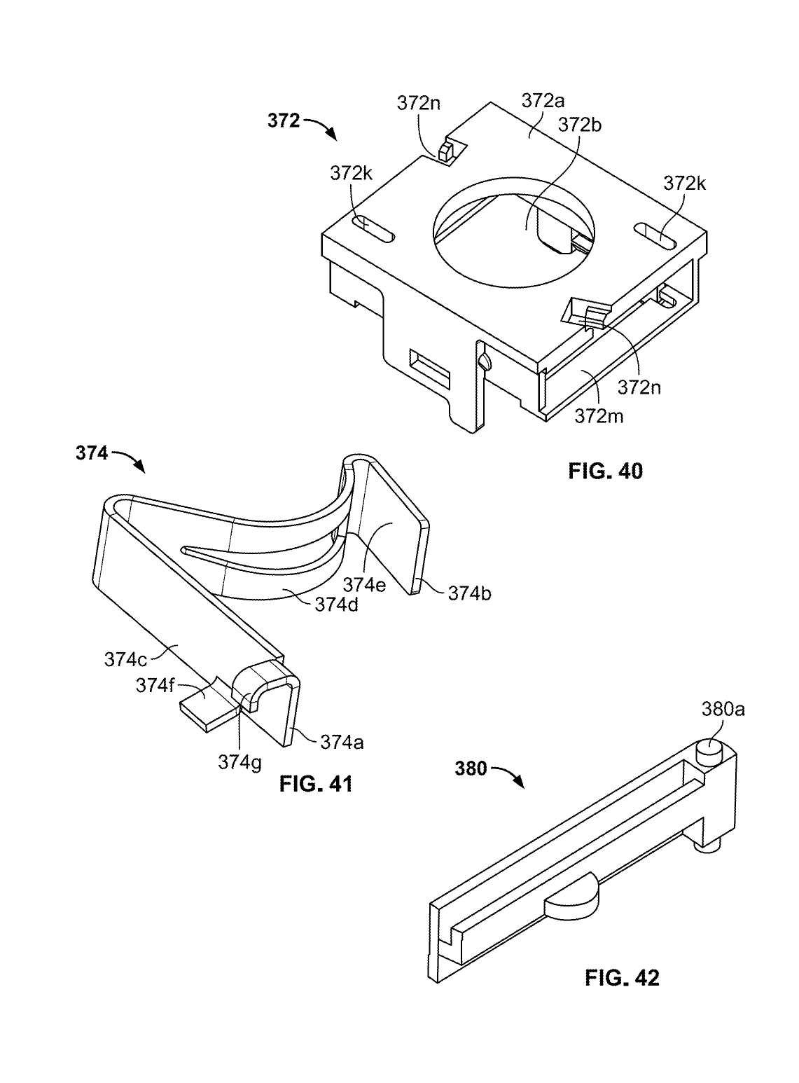

Other embodiments for a housing assembly for a connector assembly are also disclosed herein. For example, a second embodiment of a housing assembly 170 is presented at FIGS. 19-25, a third embodiment of a housing assembly 270 is presented at FIGS. 26-34, and a fourth embodiment of a housing assembly 370 is presented at FIGS. 37-42. As many of the concepts and features of the second, third, and fourth embodiments 170, 270, 370 are similar to the first embodiment shown in FIGS. 1-2 and 6-18, the description for the first embodiment is applicable to and incorporated by reference herein for the second, third, and fourth embodiments. Where like or similar features or elements are shown, the same reference numbers will be used where possible (e.g. reference number 170/270/370 instead of reference number 70 for the housing assembly). The following description for the second, third, and fourth embodiments 170, 270, 370 will be limited primarily to the differences between these embodiments and the previously described first embodiment.

As shown, the second embodiment of the housing assembly 170 shown at FIGS. 19-25 includes a housing main body 172 having a front face 172a within which a central aperture 172b is defined. Sidewalls 172e, 172f, 172g, 172h extend from the front face 172a to define a perimeter area while sidewalls 172c, 172d are provided to enable a snap-fit connection with the connector 12. A pair of clamp members 174 is also provided. Each of the clamp members 174 extends between first and second ends 174a, 174b between which first, second, and third portions 174c, 174d, 174e separated by bends are defined. The clamp members 174 are disposed between the sidewalls 172e, 172f, 172g, 172h such that the first end 174a and first portion 174c are held against sidewall 172e or 172f. The clamp members 174 are moved between clamped and open positions by a ring member 180 that is rotatably engaged with the housing part 172 and surrounds the central aperture 172b. The ring member 180 includes pins 180a that engage with the clamp members 174 at the bend location between the first and second portions 174c, 174d . Each of the clamp members 174 may include a tab portion 174f that can engage against the pin 180a to secure the clamp member 174 to the ring member 180. A backing portion 180b may also be provided on the ring member 180 to ensure the clamp member 174 remains engaged against the pin 180a.

As can be seen at FIG. 20, the ring member 180 is rotated into a position such that the clamp members 174 are in the open position. In this position, the second ends 174b of the clamp members 174 are proximate the sidewalls 172g, 172h and the clamp members 174 are outside of the area defined by the central aperture 172b. From this position, the ring member 180 can be rotated in a direction R1 which causes the pins 180a to drive the clamp members 174 towards each other and into the area defined by the central aperture 17b2. This motion of the ring member 180 causes that the clamp member second ends 174b to be driven towards the central aperture 172b and away from the sidewalls 172g, 172h. Consequently, the second portions 174d of the clamp members 174 are forcibly engaged against the cable sheath 5.

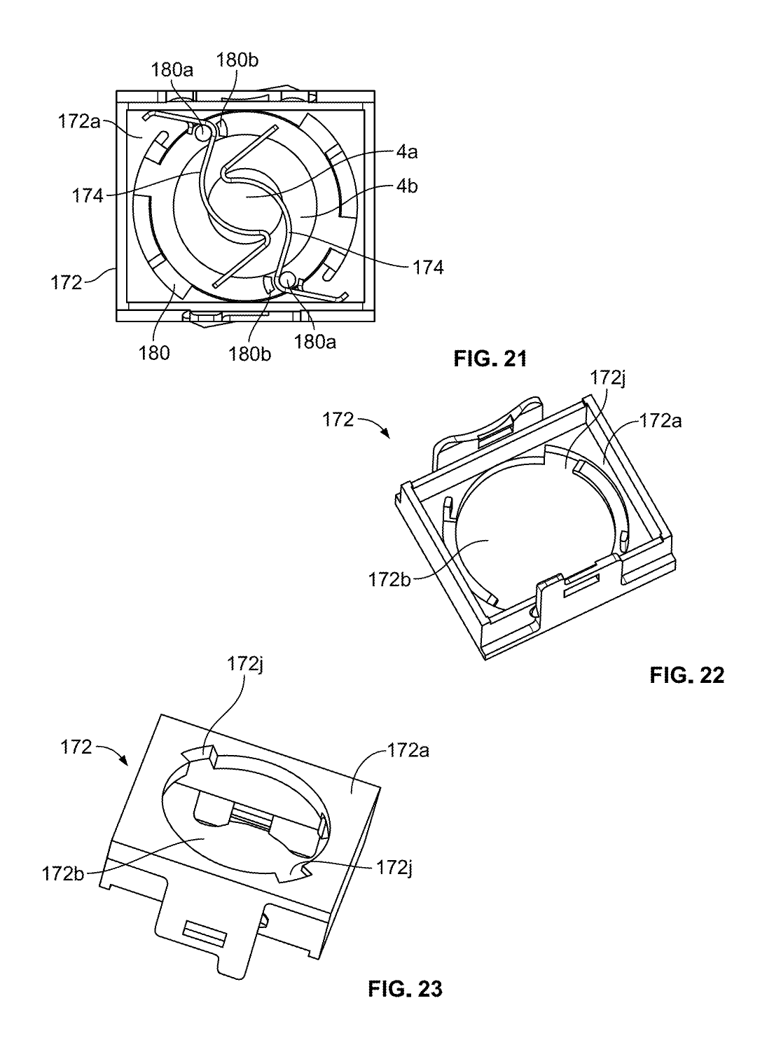

FIG. 21 shows the clamp members 174 in the clamped position, but does not show the resulting deflection of the clamp members 174 that would naturally occur with a cable 4 present within the central aperture 172b. When a cable 4 is present, the clamp members 174 will deflect about the pins 180a and along the second portions 174d. To move the clamp members 174 back to the open position, the ring member 180 can be rotated in a direction R2 which is opposite the first direction R1. To aid a user in manipulating rotation of the ring member 180, handles 180b may be provided. To secure the ring member 180 to the first housing part 172, the ring member 180 may be provided with a main surface 180e and offset tab portions 180d between which the front wall 172a is disposed. The front wall 172a may be provided with notches 172j to initially receive the tab portions 180d when initially inserting the ring member 180 into the housing part 172. Once the ring member 180 is rotated from this initial position, the main surface 180e and tab portions 180d sandwich the front wall 182a to rotatably secure the ring member 180 with respect to the housing part 172.

Referring to the third embodiment of a housing assembly 270 presented at FIGS. 26-34, it is noted that this embodiment is similar to the second embodiment 170 in that a rotational movement on a ring member 280 causes clamp members 174 to move between the open and closed positions. However, the housing assembly 270 is different in that the clamp members 274 are relatively rigid bodies that do not deflect around the cable sheath 5 and instead rotate about the pins 280a and have movement controlled by a slot 272k in the front face 272a of the housing part 272. As shown, each clamp member 274 includes a main body 274a having an arcuate or arc shaped contact surface 274b extending between a aperture 274c for receiving pin 280a and a pin 274d which extends into slot 272k.

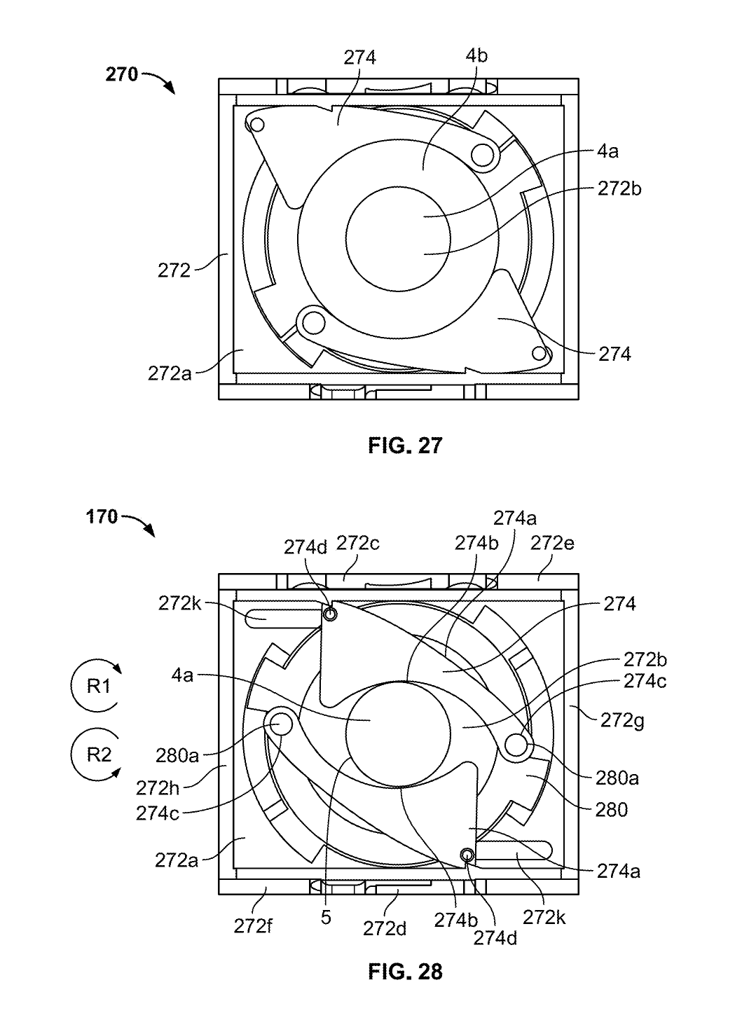

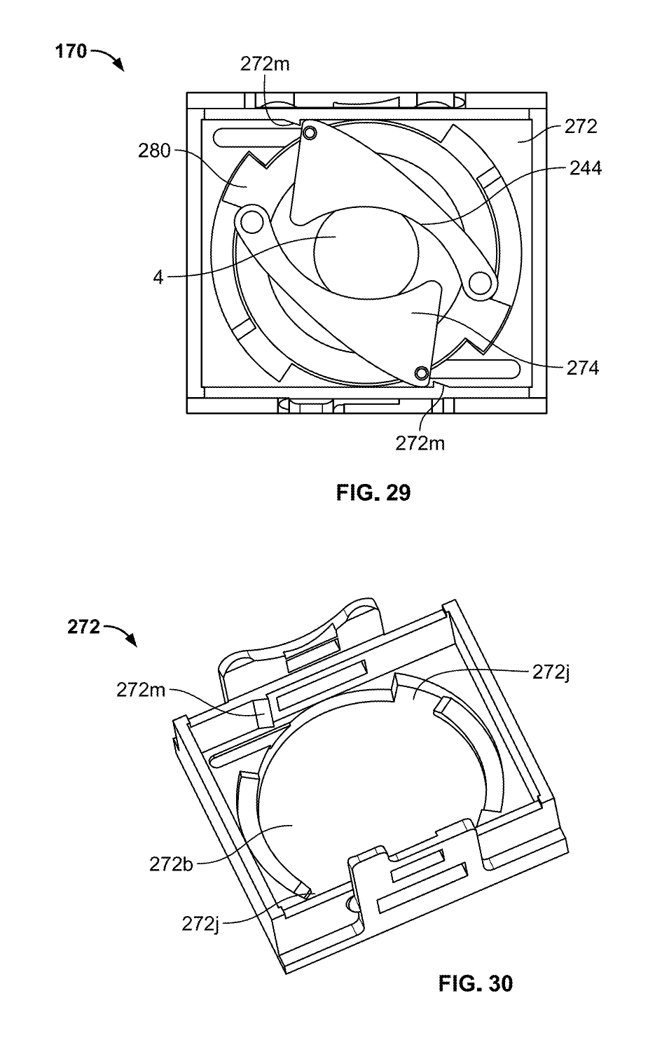

As can be seen at FIG. 28, the ring member 280 is rotated into a position such that the clamp members 274 are in a partially opened or clamped position. In this position, the clamp members 274 are sufficiently outside of the area defined by the central aperture 272b to allow the smaller cable 4a to pass through the central aperture 272b but no pressure is applied to the cable 4a. The ring member 280 and clamp members 274 are shown in the fully open position at FIG. 27. From this position, the ring member 280 can be rotated in a direction R1 which causes the pins 280a to drive the clamp members 274 towards each other and into the area defined by the central aperture 272b such that the contact surfaces 274b are drawn against the cable sheath 5. During this rotation, the clamp members 274 follow a controlled movement as the pins 274d travel along slot 272k. Once sufficiently rotated, latch members 272m can be provided on the housing part 272 to secure the ends of the clamp members 274, thereby ensuring that the clamp members 274 do not move out of the clamped position without a sufficient rotational force being applied to the ring member 280. In one example, multiple latch members 272m are provided for each clamp member 274 such that the clamp members 274 can be ratcheted down onto variously sized cables. A tool, such as a screwdriver, can be inserted to release the clamp members 274 from the latch member 272m to which it is locked against. The clamped position is shown at FIG. 27 around the sheath of a larger cable 4b and FIG. 29 around the sheath of a smaller cable 4a. As most easily seen at FIGS. 30-33, the housing part 272 and ring member 280 are similar to the second embodiment, in that the housing part 272 is provided with notched portions 272j and the ring member 280 is provided with handle portions 280c, tab portions 280d, and a main surface 280e.

Referring to the fourth embodiment of a housing assembly 370 presented at FIGS. 35-42, it is noted that this embodiment is similar to the first and second embodiments 70, 170 in that flexible clamp members 374 are placed in a deflected state to ensure clamping against a cable 4. However, rather than sliding the clamp members (e.g. first embodiment 70) or providing a rotating ring member (e.g. second embodiment 170), a rotational force is exerted on the clamp members 374 by operation of a lever arm 380 connected to the first portion 374c of the clamp member 374. As with the second embodiment, the clamp members 374 extend between a first end 374a and a second end 374b with first, second, and third portions 374c, 374d, 374e extending therebetween. The clamp members 374 can also be provided with tab members 374f, 374g for securing the clamp members 374 to the lever arms 380. A protrusion 380b on the lever arm 380 can provide tension within the tab member 374g to ensure a secure connection between the lever arm 380 and the clamp member 374.

When assembled, the clamp members 374 are oriented between a pin 372p and a backing portion 372q of the housing part 372 at the bend location between the first portion 374c and the second portion 374d. Thus, when the lever arm 380 is rotated about a pin 380a received within a slot 372k and notch 372j of the housing part 372, the second and third portions 374d, 374e of the clamp members 374 are moved towards each other and into the area defined by the central aperture 372b in the front wall 372a and against the cable sheath 5. In the clamped position, the lever arms 380 can be received into a cavity 372m of the housing part 372. The housing part 372 can be provided with a latch configuration 372n for providing a snap-fit type connection with the lever arms 380 to ensure the clamped position is maintained.

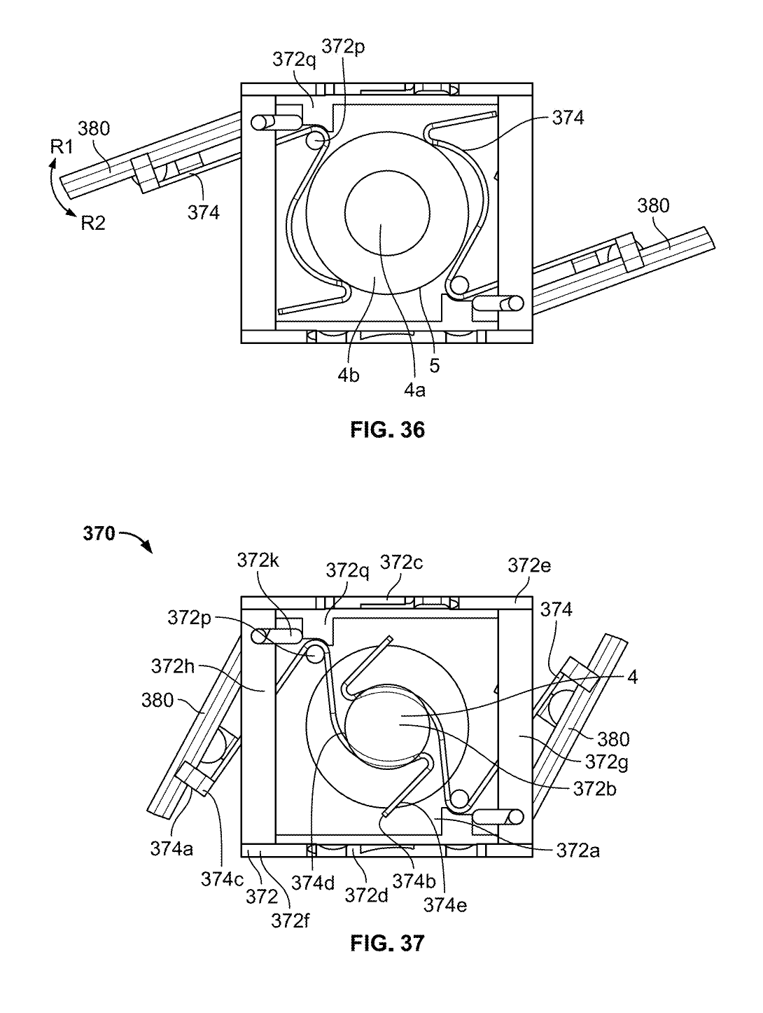

FIGS. 35 and 36 show the housing assembly 370 in the open position, FIG. 37 shows the housing assembly 370 in a partially closed position, and FIG. 38 shows the housing assembly 370 in the clamped position (however, not showing deflection that would occur around cable 4).

For each of the disclosed embodiments 70, 170, 270, 370, a wide range of cable diameters can be accommodated, for example cables ranging between 4 millimeters to 9 millimeters can be accepted and grounded by the same clamp assembly.

Many materials can be suitable closed for the components of the disclosed embodiments clamp members 70, 170, 270, 370. For example, the clamp members 74, 174, 274, 374 can be formed from a metal material, such as plated copper alloy, stainless steel, and/or zinc die-casting. The clamp member 274 is particularly well suited to formation via die-casting.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the disclosure.

### PARTS LIST

2 terminated connector and cable
4 cable
5 conductive element/sheath
6 wires or filaments
10 connector assembly
12 connector part
12a first side
12b second side
14 jack cavity
16 electrical conductors
18 cutting edges
20 cable manager part
30 lacing structure
70 housing assembly
72 first housing part main body
72a end wall
72b central aperture
72c sidewalls
72d sidewalls
72e sidewalls
72f sidewalls
72g sidewalls
72k interior sidewalls
72m interior sidewalls
72n latch members
72p latch members
72r protrusions
72s protrusions
72t apertures
72v apertures
72x channel
72y channel
74 clamp member
74a first end
74b second end
74c handle portion
74d slide portion
74e bend portion
74f clamp portion
74g end portion
74h notch
74i aperture
170 housing assembly
172 first housing part main body
172a front face or front wall
172b central aperture
172c sidewall
172d sidewall
172e sidewall
172f sidewalls
172g sidewalls
172h sidewalls
172j notch
174 clamp member
174a first end
174b second end
174c first portion
174d second portion
174e third portion
174f tab portion
180 ring member
180a pin
180b handle
180d tab portion
180e main surface
270 housing assembly
272 housing part
272a front face or front wall
272b central aperture
272c sidewall
272d sidewall
272e sidewall
272f sidewall
272g sidewall
272h sidewall
272j notched portion
272k slot
272m latch member
274 clamp member
274a main body
274b contact surface
274c aperture
274d pin
280 ring member
280a pin
280c handle portion
280d tab portions
280e main surface
370 housing assembly
372a front face or front wall
372b central aperture
372c sidewall
372d sidewall
372e sidewall
372f sidewall
372g sidewall
372h sidewall
372j notch
372k slot
372m cavity
372n latch configuration
372p pin
372q backing portion
374 clamp member
374a first end
374b second end
374c first portion
374d second portion
374e third portion
374f tab members
374g tab member
380 lever arm
380a pin
380b protrusion

1. A connector assembly comprising:
a) a connector part having a jack cavity;
b) a cable manager part conductively attached to the connector part, the cable manager part having:
i) a housing assembly having a housing part defining a central aperture through which a cable having an exposed conductive element can extend;
ii) a grounding clamp assembly held within the housing part, the grounding clamp assembly including a first clamp member and an oppositely arranged second clamp member, the first and second clamp members being movable between an open position and a clamped position:
1) in the open position, the clamp members being disposed away from the central aperture and being in a relaxed state;
2) in the clamped position, the clamp members extending across the central aperture and contacting the conductive element of an inserted cable by one or both of bending around the conductive element in a deflected state and rotating against the conductive element.

2. The connector assembly of claim 1, wherein the clamp members are moved between the open and clamped position by displacing the clamp members in a linear direction.

3. The connector assembly of claim 1, wherein the clamp members are formed from a metal material.

4. The connector assembly of claim 1, wherein the clamp members have a handle portion for grasping the clamp members.

5. The connector assembly of claim 1, wherein the clamp members include an aperture for increasing the flexibility of the clamp members.

6. The connector assembly of claim 1, wherein the grounding cable manager part further includes a ring member rotatably disposed within the first housing part, the ring member being rotatable to move the clamp members between the open and clamped positions.

7. The connector assembly of claim 6, wherein the ring member includes at least one handle member for manipulating the ring member.

8. The connector assembly of claim 6, wherein each clamp member is a rigid body.

9. The connector assembly of claim 6, wherein the ring member includes a pair of posts for engaging with the clamp members.

10. The connector assembly of claim 1, wherein the grounding cable manager part includes a pair of lever arms engaged with the clamp members.

11. The connector assembly of claim 10, wherein the lever arms are rotatable to move the clamp members between the open and clamped positions.

12. The connector assembly of claim 11, wherein the lever arms are received within cavities of the housing part when the clamp members are in the clamped position.

13. A connector assembly comprising:
a) a connector part having a jack cavity;
b) a cable manager part conductively attached to the connector part, the cable manager part having:
i) a housing assembly having a housing part defining a central aperture through which a cable having an exposed conductive element can extend;
ii) a grounding clamp assembly held within the housing part, the grounding clamp assembly including a first clamp member and an oppositely arranged second clamp member, the first and second clamp members being movable between an open position and a clamped position:
1) in the open position, the clamp members being disposed away from the central aperture and being in a relaxed state;
2) in the clamped position, the clamp members extending across the central aperture and contacting the conductive element of an inserted cable by bending around the conductive element in a deflected state.

14. The connector assembly of claim 13, wherein the clamp members are moved between the open and clamped position by displacing the clamp members in a linear direction.

15. The connector assembly of claim 13, wherein the clamp members are formed from a metal material.

16. The connector assembly of claim 1, wherein the clamp members include an aperture for increasing the flexibility of the clamp members.

17. A connector assembly comprising:
a) a connector part having a jack cavity;
b) a cable manager part conductively attached to the connector part, the cable manager part having:
i) a housing assembly having a housing part defining a central aperture through which a cable having an exposed conductive element can extend;
ii) a grounding clamp assembly held within the housing part, the grounding clamp assembly including a first clamp member and an oppositely arranged second clamp member, the first and second clamp members being movable between an open position and a clamped position:
1) in the open position, the clamp members being disposed away from the central aperture and being in a relaxed state;
2) in the clamped position, the clamp members extending across the central aperture and contacting the conductive element of an inserted cable by rotating against the conductive element.

18. The connector assembly of claim 17, wherein the grounding cable manager part further includes a ring member rotatably disposed within the first housing part, the ring member being rotatable to move the clamp members between the open and clamped positions.

19. The connector assembly of claim 18, wherein the ring member includes at least one handle member for manipulating the ring member.

20. The connector assembly of claim 18, wherein each clamp member is a rigid body.

21.-26. (canceled)
